(19) United States
(12) Patent Application Publication
(10) Pub. No.: US 2012/0097267 A1
(43) Pub. Date: Apr. 26, 2012

(54) WATER SUPPLY CONTROL DEVICE AND METHOD

(75) Inventors: CHE-YI CHU, Tu-Cheng (TW); CHUN-HUNG LEE, Tu-Cheng (TW)

(73) Assignee: HON HAI PRECISION INDUSTRY CO., LTD., Tu-Cheng (TW)

(21) Appl. No.: 13/211,317

(22) Filed: Aug. 17, 2011

(30) Foreign Application Priority Data
Oct. 20, 2010 (TW) 99135720

(51) Int. Cl. F16K 31/00

(52) U.S. Cl. 137/391

(57) ABSTRACT

A water supply control method for a water tower connected to a server through a high water level sensor and a low water level sensor installed on the water tower. A solar panel is controlled to supply power to a motor of the water tower during off-peak hours and a current water level in the water tower has reached a lowest water level but has not reached a highest water level. An alternating current power supply is controlled to supply power to the motor during off-peak hours and the current water level in the water tower has not reached the lowest water level, or during peak hours and the current water level in the water tower has not reached the highest water level.

### BACKGROUND

1. Technical Field

Embodiments of the present disclosure generally relate to water supply technology, and more particularly to a water supply control device and method.

2. Description of Related Art

A water supply system, such as a water tower, may use alternating current (AC) power to drive motors, which can be costly. The system may instead use an environmentally-friendly power supply equipment and operate on wind power or solar energy which at this time are inefficient. Therefore, what is needed is an improved water supply control device to save costs and increase efficiency.

### BRIEF DESCRIPTION OF THE DRAWINGS

FIG. 1 is a block diagram of one embodiment of a water supply control device.

FIG. 2 is a flowchart of one embodiment of a water supply control method.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

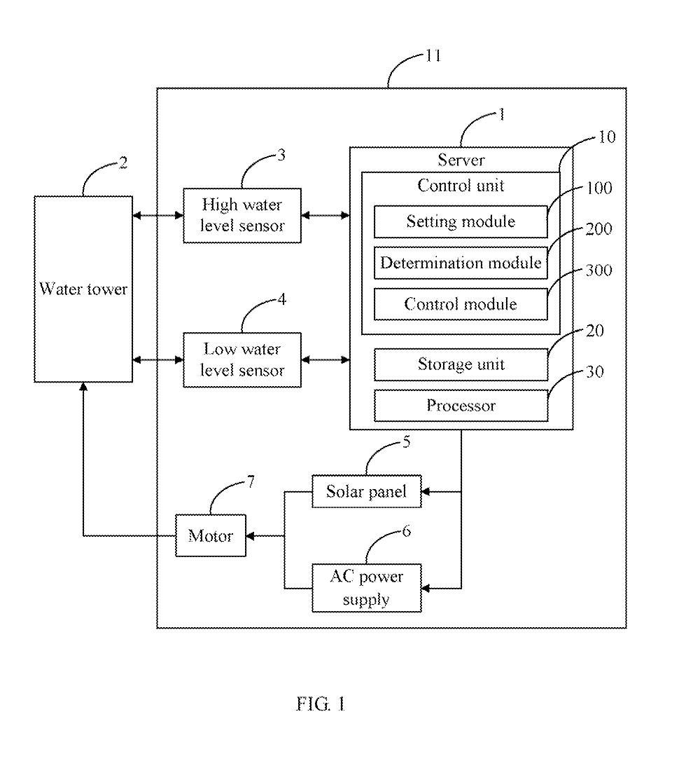

FIG. 1 is a block diagram of one embodiment of a water supply control device 11. In one embodiment, the water supply control device 11 includes a server 1, a high water level sensor 3, a low water level sensor 4, a solar panel 5, an alternating current (AC) power supply 6, and a motor 7. The server 1 is electrically connected to the high water level sensor 3 and the low water level sensor 4, which are installed on a water tower 2. The server 1 includes a control unit 10, and is operable to control the solar panel 5 or the

AC power supply 6 to supply power to the motor 7, and thereby supply water to the water tower 2. In other embodiments, the solar panel 5 can be replaced with a wind power generator or other power generation equipment using natural energy.

The high water level sensor 3 detects whether the a current water level in the water tower 2 has reached a highest water level, and notifies the server 1 accordingly. The low water level sensor 4 detects whether the current water level in the water tower 2 has reached a lowest water level, and notifies the server 1 accordingly.

In one embodiment, the control unit 100 includes a setting module 100, a determination module 200, and a control module 300. The modules may comprise computerized code in the form of one or more programs that are stored in a storage unit 20, and executed by a processor 30 of the server 1 to provide the functions of the control unit 100 described later. The storage unit 20 may be a cache or a memory, such as an EPROM, HDD, or flash memory.

The setting module 100 is operable to set the highest water level and the lowest water level in the water tower 2, and set a peak time (such as 18:00-22:00) of water use of the water tower 2. It is noted that the peak time of water use is a peak period of water demand.

The determination module 200 is operable to determine whether a current time is during the peak time.

The determination module 200 is further operable to determine whether the current water level in the water tower 2 has reached the lowest water level according to the results sent by the low water level sensor 4.

The determination module 200 is further operable to determine whether the current water level in the water tower 2 has reached the highest water level according to the results sent by the high water level sensor 3.

The control module 300 is operable to control the solar panel 5 or the AC power supply 6 to supply power to the motor 7. In one embodiment, the control module 300 is operable to control the solar panel 5 to supply power to the motor 7 when the current time is not during the peak time and the current water level has reached the lowest water level but has not reached the highest water level, to raise the water level in the water tower 2 to reach the highest water level. The control module 300 is further operable to control the AC power supply 6 to supply power to the motor 7 when the current time is not during the peak time and the current water level has not reached the lowest water level, or when the current time is during the peak time and the current water level has not reached the highest water level, to raise the water level in the water tower 2 to reach the highest water level.

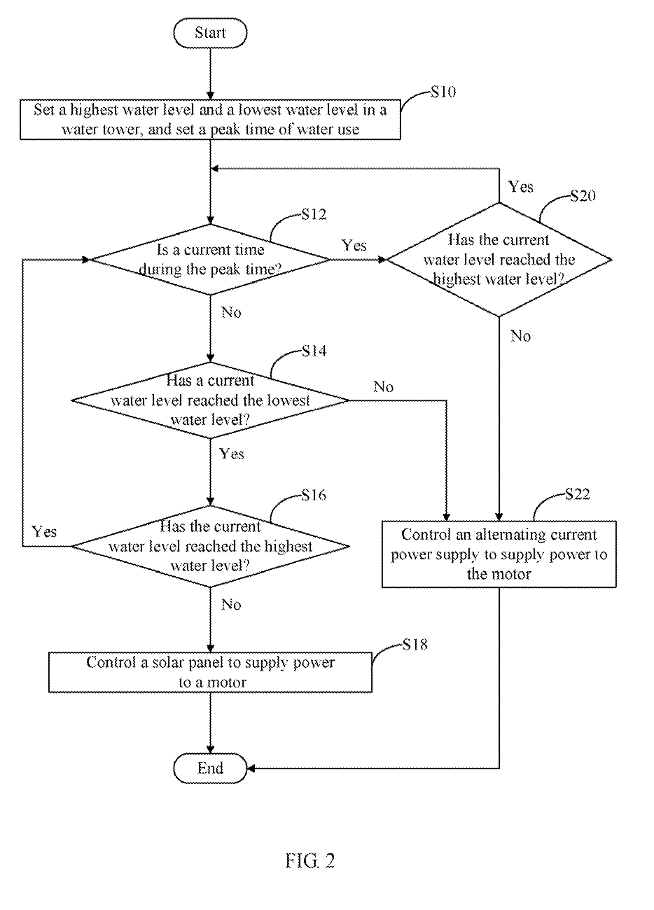

FIG. 2 is a flowchart of one embodiment of a water supply control method. Depending on the embodiment, additional blocks may be added, others removed, and the ordering of the blocks may be changed.

In block S10, the setting module 100 sets the highest water level and the lowest water level in the water tower 2, and sets a peak time of water use of the water tower 2.

In block S12, the determination module 200 determines whether a current time is during the peak time. If the current time is during the peak time, block S20 is implemented. Otherwise, if the current time is not during the peak time, block S14 is implemented.

In block S14, the determination module 200 determines whether the current water level in the water tower 2 has reached the lowest water level according to the results sent by the low water level sensor 4. If the current water level has reached the lowest water level, block S16 is implemented. Otherwise, if the current water level has not reached the lowest water level, block S22 is implemented.

In block S16, the determination module 200 determines whether the current water level in the water tower 2 has reached the highest water level according to the results sent by the high water level sensor 3. If the current water level has reached the highest water level, the procedure returns to block S12. Otherwise, if the current water level has not reached the highest water level, block S18 is implemented.

In block S18, the control module 300 controls the solar panel 5 to supply power to the motor 7, to raise the water level in the water tower 2 to reach the highest water level. Then, the procedure ends.

In block S20, the determination module 200 determines whether the current water level in the water tower 2 has reached the highest water level according to the results sent by the high water level sensor 3. If the current water level has reached the highest water level, the procedure returns to block S12. Otherwise, if the current water level has not reached the highest water level, block S22 is implemented.

In block S22, the control module 300 controls the AC power supply 6 to supply power to the motor 7, to raise the water level in the water tower 2 to reach the highest water level. Then, the procedure ends.

It is noted that the procedure in FIG. 2 is only one circulation of the water supply control method. Block S12 to block S22 of the procedure can be executed repeatedly until there is no need to control supplying water to the water tower 2.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A water supply control method being executed by a processor of a server, the method comprising:
(a) setting a highest water level and a lowest water level of water in a water tower, and setting a peak time of water use of the water tower;
(b) determining whether a current time is during the peak time, and comparing a current water level in the water tower with the highest water level and lowest water level; and
(c) controlling power generation equipment to supply power to a motor of the water tower in response that the current time is not during the peak time and the current water level in the water tower has reached the lowest water level but has not reached the highest water level, to raise the water level in the water tower to reach the highest water level; or
(d) controlling an alternating current power supply to supply power to the motor in response that the current time is not during the peak time and the current water level in the water tower has not reached the lowest water level, or in response that the current time is during the peak time and the current water level in the water tower has not reached the highest water level, to raise the water level in the water tower to reach the highest water level.

2. The water supply control method as claimed in claim 1, wherein the method further comprises:
returning to block (b) in response that the current water level in the water tower has reached the highest water level.

3. The water supply control method as claimed in claim 1, wherein the method further comprises:
using a high water level sensor electronically connected to the server and installed on the water tower to detect whether the current water level in the water tower has reached the highest water level; and
using a low water level sensor electronically connected to the server and installed on the water tower to detect whether the current water level in the water tower has reached the lowest water level.

4. The water supply control method as claimed in claim 1, wherein the power generation equipment is a solar panel or a wind power generator.

5. A non-transitory storage medium storing a set of instructions, the set of instructions capable of being executed by a processor to perform a water supply control method, the method comprising:
(a) setting a highest water level and a lowest water level of water in a water tower, and setting a peak time of water use of the water tower;
(b) determining whether a current time is during the peak time, and comparing a current water level in the water tower with the highest water level and lowest water level; and
(c) controlling power generation equipment to supply power to a motor of the water tower in response that the current time is not during the peak time and the current water level in the water tower has reached the lowest water level but has not reached the highest water level, to raise the water level in the water tower to reach the highest water level; or
(d) controlling an alternating current power supply to supply power to the motor in response that the current time is not during the peak time and the current water level in the water tower has not reached the lowest water level, or in response that the current time is during the peak time and the current water level in the water tower has not reached the highest water level, to raise the water level in the water tower to reach the highest water level.

6. The non-transitory storage medium as claimed in claim 5, wherein the method further comprises:
returning to block (b) in response that the current water level in the water tower has reached the highest water level.

7. The non-transitory storage medium as claimed in claim 5, wherein the method further comprises:
using a high water level sensor electronically connected to the server and installed on the water tower to detect whether the current water level in the water tower has reached the highest water level; and
using a low water level sensor electronically connected to the server and installed on the water tower to detect whether the current water level in the water tower has reached the lowest water level.

8. The non-transitory storage medium as claimed in claim 5, wherein the power generation equipment is a solar panel or a wind power generator.

9. A server, the server comprising:
a storage unit;
at least one processor; and
one or more programs stored in the storage unit, executable by the at least one processor, the one or more programs comprising:
a setting module operable to set a highest water level and a lowest water level of water in a water tower, and setting a peak time of water use of the water tower;
a determination module operable to determine whether a current time is during the peak time, and compare a current water level in the water tower with the highest water level and lowest water level;
a control module operable to control power generation equipment to supply power to a motor of the water tower in response that the current time is not during the peak time and the current water level in the water tower has reached the lowest water level but has not reached the highest water level, to raise the water level in the water tower to reach the highest water level; and
the control module further operable to control an alternating current power supply to supply power to the motor in response that the current time is not during the peak time and the current water level in the water tower has not reached the lowest water level, or in response that the current time is during the peak time and the current water level in the water tower has not reached the highest water level, to raise the water level in the water tower to reach the highest water level.

10. The server as claimed in claim 9, wherein:
a high water level sensor connected to the server and installed on the water tower is used to detect whether the current water level in the water tower has reached the highest water level, and send results to the server; and
a low water level sensor connected to the server and installed on the water tower is used to detect whether the current water level in the water tower has reached the lowest water level, and send results to the server.

11. The server as claimed in claim 9, wherein the power generation equipment is a solar panel or a wind power generator.
